(19) United States
(12) Patent Application Publication
(10) Pub. No.: US 2007/0022209 A1
(43) Pub. Date: Jan. 25, 2007

(54) Processing of data frames exchanged over a communication controller in a time-triggered system

(76) Inventors: Martin Delvai, Wien (AT); Harald Angelow, Wien (AT); Gerhard Konighofer, Neunkirchen (AT)

Correspondence Address: RATNERPRESTIA, P O BOX 980, VALLEY FORGE, PA, 19482-0980, US

(21) Appl. No.: 11/476,545

(22) Filed: Jun. 28, 2006

(30) Foreign Application Priority Data
Jun. 28, 2005 (AT) A 1091/2005

(51) Int. Cl. G06F 15/16

(52) U.S. Cl. 709/236

(57) ABSTRACT

Data frames which are exchanged over a communication controller are processed between a host computer and a time-triggered communication network. A data frame is read by a processor located in the communication controller from an interface data storage unit accessible over a first interface. The data contained in the data frame is processed according to packaging information contained in a configuration table, and portions of the user data are stored in the data frame in an associated memory range or set of registers of the interface data storage means as defined in the packaging information.

This application claims priority to Austrian application no. A 1091/2005, filed Jun. 28, 2005

### FIELD OF THE INVENTION

The invention relates to the processing of data frames which are exchanged over a communication controller between a host computer and a time-triggered communication network in a time-triggered system. A communication controller of said kind realizes a communications network interface between a host computer and a time-triggered communication network (e.g., a TTP bus).

### BACKGROUND

Time-triggered communication systems (e.g. TTP or FlexRay) offer a dependable communication solution for distributed embedded real-time systems. Due to the higher speeds that are achievable with time-triggered communication systems compared to conventional event triggered communication systems the amount of data handling and processing will typically increase for the individual node. This introduces a strong requirement for efficiency of the data handling.

At the same time safety-critical functions are currently introduced in many application domains (e.g. XbW in vehicle industries). This leads to the requirement of simple validation and verification of the communication solution.

Time-Triggered Protocols (TTP) are designed for implementing a time-triggered real-time system. For time-triggered systems the use of a communication layer, such as the FT-COM defined by OSEK consortium (http://www.osek-vdx.org) or the TTTech Computertechnik AG FT-COM product implementation, is state of the art. Common to these communication layers is that they are executed on the host-CPU and by this the application software has to share processing time on the host-CPU with the communication layer.

Mostly two types of FT-COM are in use:
execution time optimized FT-COM such as the TTTech FT-COM: The TTTech FT-COM generates optimized tasks for communication handling. The result of the optimized generation will change, if processing or communication requirements are changed.
table-driven FT-COM: a task is called via a table entry to start the data handler from a library. For each data handling a function call must be issued. The advantage of this solution is that the library has to be certified only once.

A table-driven FT-COM is often preferred due to reduced certification overhead, since only a one-time effort for certification is needed for the library of a table-driven realization, whereas for an optimized FT-COM certification has to be re-done completely. For the table-driven approach only the table needs to be re-certified in case of changes in the nodes schedule which may be done by an independent tool.

The following explanation referring to FIG. 2 is meant to clarify several expressions and terms used in this disclosure: Data which is transmitted/received in a TDMA slot (denoted TSn in FIG. 2) through a single communication channel, is called a Data Frame or, simply, a Frame. Two Frames F0, F1, sent via the channels Ch0, Ch1 respectively, are shown in the upper part of FIG. 2. From a logical point of view a Frame is composed by an arbitrary number of messages (denoted by capital letters A through G), which in turn are grouped into Message Boxes (denoted MsgBox1 through MsgBox6). All messages of a Message Box have an independent content, but share a common Message Box Status (denoted MBS). The smallest Message Box consists of only one message. TTP controllers are equipped with two communication channels Ch0, Ch1, herein also referred to as Channel 0 and Channel 1. Both channels may carry the same data (=redundant messages, in FIG. 2 identified by identical capital letters) and/or individual messages. The scope of redundant messages is to improve the reliability of the communication process. However, the application itself does not need the same information twice. Therefore, we distinguish between Frames and Virtual Frames (V-Frames): A V-Frame merges the information received in a single time slot on both channels, whereas redundant information is contained in the V-Frame only once. In FIG. 2 a V-Frame VF2 is shown corresponding to the two Frames F0 and F1. We use the term unpacking (or, to unpack) for a process where Frames are merged to a V-Frame. Contrariwise we use the term packing (or, to pack), whenever the V-Frame figures as source and the Data Frames are generated from it. In this sense we use the term “packed frame” to refer to the content of a Frame and “unpacked frame” to refer to the content of a V-Frame. Furthermore this terminology should suggest, that Frames contain the information packed in a bit stream, while a V-Frame contains the same information in a structured manner (and without redundancy). Note that the Frame Status (FS) is generated by the SCL (Synchronization and Communication Layer) on receipt, the Message Box Status by the hardware FT/COM during the unpack procedure. Thus, when a V-Frame is packed and the respective Frames are transmitted, no status information has to be added at the side of the sender. The expression Action Time is used to refer to the point in time where a V-Frame/Frame should be processed by the hardware FT/COM.

Furthermore, the following abbreviations are used in this disclosure:
C-MEDL: COM Layer Message Descriptor List—memory block containing HFTL configuration
CNI: Communications Network Interface—memory block realizing an interface data storage means for data exchange between two layers HL and SCL.
HL: Host Layer—the application layer running in the host computer.
HIL: Host Interface Layer—used to exchange data between host computer and the design connected below the HIL. It shall support both sides, the host timing and the design connected below the HIL.
HFTL: Hardware Fault Tolerance Layer—used to unload the host CPU of a communication node providing a hardware support for low level tasks, such as handling redundancy or pack/unpack messages, which originally were implemented in software.
SCL: Synchronization and Communication Layer—the SCL is synchronizing message schedules.

Time-triggered systems are further described by H. Kopetz, in “Real-time systems: design principles for distributed embedded applications”, Kluwer Academic Publishers 1997. For the purpose of the invention, reference is made, in particular, to subsections 1.5.5, 2.1.2, 2.1.3, 4.4.2, and 8.1.2 of that book.

As already mentioned, prior implementations of the FT-COM provide the complete functionality in software located at the host computer. This may lead to a considerable processing time overhead at the host. Moreover, time-triggered COM-Tasks must be scheduled to extract messages from frames before the frame buffer is overwritten; causing interruption of application tasks and a resulting task switching and processing time overhead.

### SUMMARY OF THE INVENTION

The present invention overcomes the above-mentioned drawbacks of prior art, and relieves the host computer of the tasks of a communication node, providing a hardware support for the associated low level tasks.

In an exemplary embodiment, a method for processing data frames exchanged over a communication controller between a host computer and a time-triggered communication network, comprises
reading (accessing) a data frame from an interface data storage means accessible over a first interface,
processing at least part of the data frame in at least one processor means, wherein the data contained in said data frame is processed according to packaging information contained in a configuration table, and
storing portions of the user data in the data frame in an associated memory range or set of registers of said interface data storage means as defined in said packaging information.

The present invention reduces the processing requirements on the host-CPU by provision of a separate co-processor that may run independently from the host. In contrast to a table-driven solution the hardware module avoids explicit calls through the time-triggered activation of operations. The complete functionality of the communication (COM) layer can be implemented in hardware, thus avoiding task switching and processing time overheads. It is, however, not necessary to implement the FT part in hardware since this part represents only a minor part of the FTCOM runtime.

Therefore, the invention allows more efficient schedules and can dramatically decrease the COM overhead. This will be of special importance for applications like those in the automotive field where it is anticipated that, with upcoming data rate and more complex architectures, also COM overhead will increase. Using a HW COM layer may free up to 80% CPU load at the host and prevent application tasks from interruption.

In an exemplary embodiment, the processing according to the configuration table comprises adjusting the data format, by at least one of adjusting to the word length of the host computer, adjusting the byte order to that of the host computer, and/or adjusting the data range or set of registers of user data processed.

Relating to unpacking of frames, preferably, data which is originating from the host computer and designed to be sent to the communication network, may be composed into a data frame using data from at least two memory regions described by the host computer according to the configuration table. In an exemplary embodiment, data designed to be sent may be composed into a data frame from at least two memory ranges or sets of registers or any combination of memory range and set of registers described by the host computer according to the configuration table; the memory ranges or being set/reset to a pattern (e.g., all bits ‘0’ or ‘1’) after the data frame has been sent.

Additionally, a data status may be generated, said data status comprising information about the channel over which the data are received, information whether data are sent in a redundant way, as well as a message age. Preferably, newly received but unvalidated data is prevented from overwriting valid data and the message age of the data present in the memory or set of registers is adapted accordingly.

Furthermore, it is advantageous when in the configuration table the times are defined when the data are read/written in the memory regions jointly used with the host computer and/or the memory regions jointly used with the communication controller.

The address where the data are made available to the host computer may suitably be stored in the configuration table. The configuration table may further describe the types of operations which are executed during the data transfer between the communication controller and the host computer.

In the case of redundant data, transfer portions of valid data may, preferably, be selected according to a prescription defined in the configuration table, in order to make data portions received in a redundant way available to the host computer only once. In this case, the redundant data portions are suitably checked for equality.

In an exemplary embodiment of the invention, different tasks belonging to the processing of data frames may be performed in parallel in a number of processing means provided in the communication controller.

In an exemplary embodiment, a processing device for a communication controller processes data frames exchanged between a host computer and a time-triggered communication network, having
a processor means, and
a first interface for accessing an interface data storage means, wherein said processor means is adapted to process at least part of a data frame read from said interface data storage means according to packaging information contained in a configuration table, and to store portions of user data in the data frame in an associated memory range or set of registers of said interface data storage means as defined in said packaging information.

The advantages of this device according to the invention were discussed with the method above. It should be noted that the processing device may be realized in a single module or chip, or may be realized by an arrangement of components.

In an exemplary embodiment, the processing device may further comprise the configuration table. Furthermore, it is contemplated that the processing device may comprise a second interface adapted to be connected to the host computer for the exchange of packaging information, and/or a third interface adapted to be connected to a protocol processor of said communication controller for the exchange of synchronization data such as a time reference signal.

### BRIEF DESCRIPTION OF THE DRAWINGS

In the following, the present invention is described in more detail, with reference to the drawings showing respectively:

FIG. 1 shows the hardware structure of a Communication Node supplied with a processing module according to an exemplary embodiment of the invention;

FIG. 2 illustrates the Frame and V-Frame structure;

FIG. 3 depicts the basic structure of the processing module shown in FIG. 1;

FIG. 4 shows architecture having multiple processing units according to an exemplary embodiment of the invention;

FIG. 5 shows multiple processing units sharing a common configuration table according to an exemplary embodiment of the invention;

FIG. 6 is a block diagram showing the internal structure of a Packaging Engine contained in the processing module of FIG. 3; and

FIG. 7 depicts the partitioning of the C-MEDL memory.

### DETAILED DESCRIPTION OF THE INVENTION

In the following, an exemplary embodiment of a processing device according to the invention, called ‘Hardware FT/COM’ (which is not to be confused with the term FT-COM used in the above introduction), is discussed. The processing device can be realized in hardware, preferentially as a stand-alone component, serving as a co-processor to the CPU of the host computer. Of course the invention is not limited to this specific embodiment; rather, those skilled in the art will recognize there are many other ways implementing the scope and spirit of the present invention.

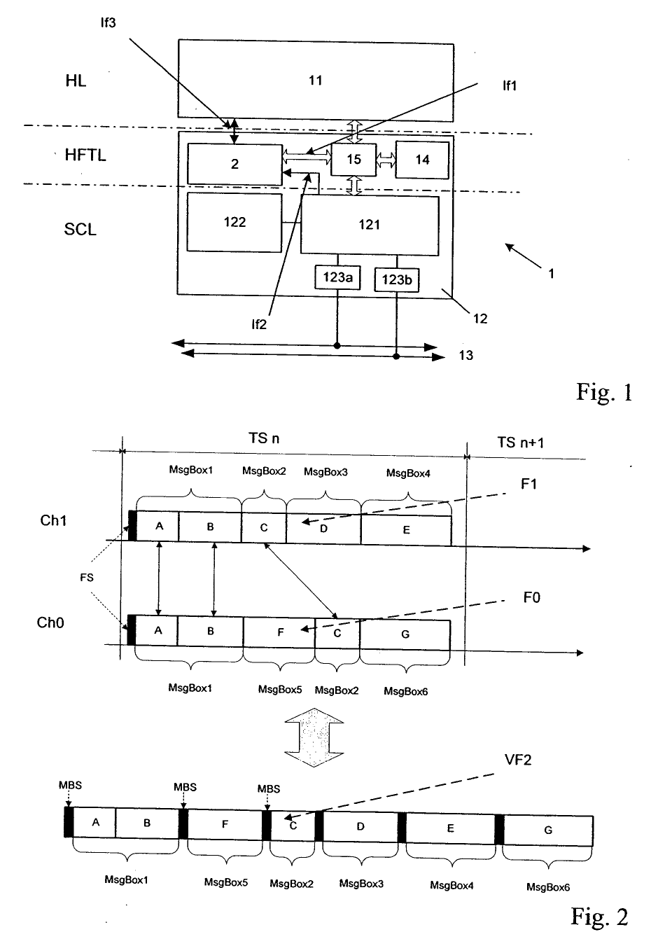

FIG. 1 shows a communication node 1 which may include a host computer 11 connected to a communication network 13 through a communication controller 12 (TTP controller), equipped with a Hardware FT/COM device 2 according to the invention. The Hardware FT/COM device 2 may serve as a host-independent COM layer processing device and may provide a packaging service, which may handle redundancy and generate message status information. The structure shown in FIG. 1 is a development from the hardware structure of a “conventional” TTP node (shown in FIG. 8.2 of subsection 8.1.2 in the above-mentioned book by H. Kopetz), which implements the FT/COM functionality in software. Further components of the TTP controller 12 are a protocol processor 121 with associated TTP control data 122 realized in ROM, and bus guardians 123a, 123b. The protocol processor 121 may realize the SCL functions. The CNI (which may serve as an interface data storage) may be realized as a RAM device 14 which may be accessible by means of a memory management unit 15 (MMU).

In an exemplary embodiment, the hardware FT/COM device 2 may relieve the host computer 11 of the tasks of a communication node, providing a hardware support for low level tasks of the CNI.

The data, which may be packed/unpacked by the hardware FT/COM, is located in the CNI memory 14, which can be accessed over the MMU interface If1. Furthermore, the hardware FT/COM 2 may get a Time Reference as well as a C-MEDL Description Identifier to be able to run synchronously to all other components in the system. This information may be provided by the SCL via an SCL interface If2.

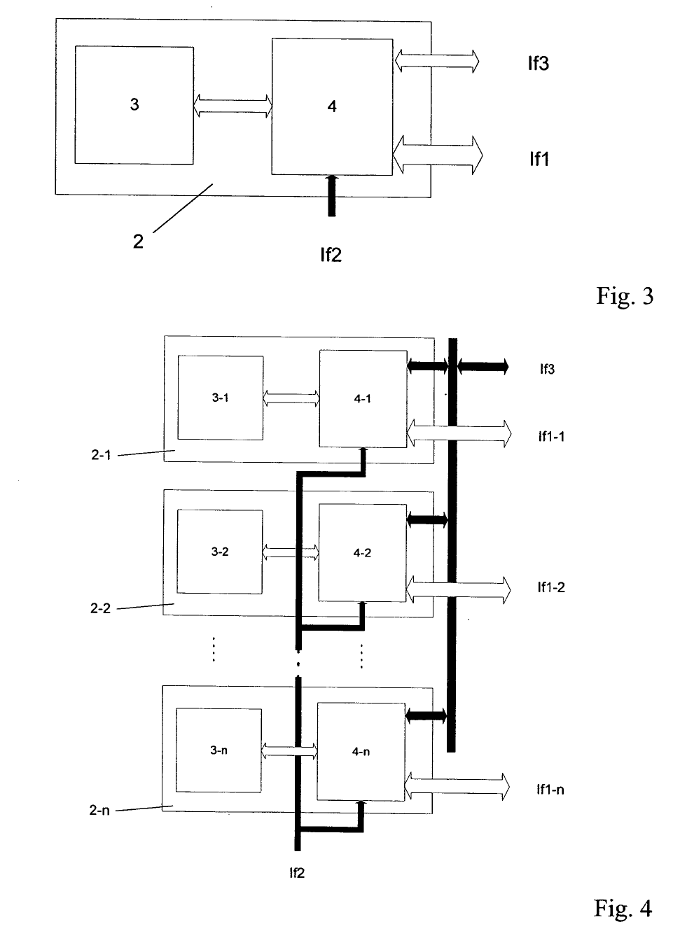

As shown in FIG. 3, the device 2 may include two components:
a memory 3 containing the packaging information, which memory is called C-MEDL (short for COM Layer MEDL) in the context of this embodiment;
a Packaging Engine 4.

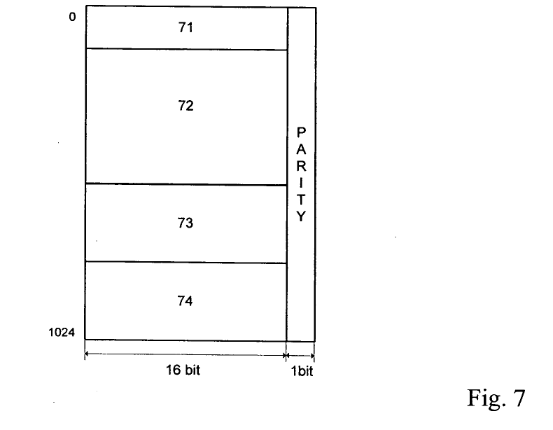

Referring to FIG. 7, the size of the C-MEDL memory implementation of the shown exemplary embodiment is 1024×17 bits. The upper 16 bits may be used for the payload data and the least significant bit for parity protection. In contrast to the memory width, the number of lines, in this case 1024, may have only a marginal impact to the resulting hardware implementation. Increasing the memory size may require adding a bit to the address bus only. The remaining hardware may be left unchanged.

From a logical point of view the C-MEDL memory may be partitioned in four parts:
C-MEDL Header Area 71: The header area starts at the beginning of the C-MEDL memory.
C-MEDL Description Area 72: Contains an applications specific number of C-MEDL descriptions, which contain the packaging information of individual cluster rounds.
Data Type Description Area 73: This area contains the descriptions of data types. These data types may be used to define the structure of individual Messages.
Public Data Type Description Area 74: Frequently used data types may be stored here.
Although message structures may be quite different, there may exist a set of commonly used data types such as byte, word, double word and so on. Data types such as arrays or structures refer to their contained elements through pointers. The limited size of these pointers may require that identical data types referred from different arrays/structures be instantiated several times. To avoid this multiply instantiations a public data type area was introduced. Structures and array can address this area through absolute pointers

In the context of the embodiment, the packaging information will be referred to as C-MEDL description. Beyond pure message structure definitions, the C-MEDL description advantageously contains further parameters, such as point in time, where messages may be processed, their location in the CNI memory, etc. The C-MEDL 21 is, preferably, held by the processing device 2 and may not be controlled by the CPU of the host computer 11. The packaging information may be provided to the hardware FT/COM device 2 during initialization phase by the Host. An additional host interface If3 may be used for the exchange of that information.

In order to improve the packaging performance, several instantiations of a hardware FT/COM can be packed into a single chip, as illustrated in FIG. 4. All hardware FT/COM instantiations 2-1, 2-2, . . . 2-n operate concurrently—which part of a (V-)Frame(s) each instantiation processes can suitably be defined in the C-MEDL 3-1, . . . 3-n.

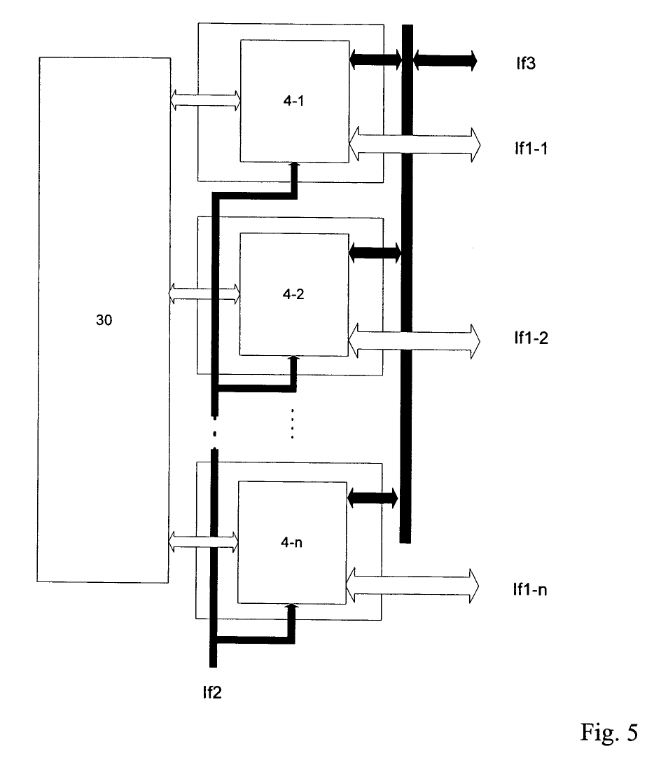

It is also possible to use a common C-MEDL 30 for all Packaging Engines 4-1, ... 4-n as depicted in FIG. 5, in order to save memory resources. This, however, implies that the C-MEDL memory bandwidth is shared between all Packaging Engines, which may penalize the packaging performance of the resulting architecture.

Note that consistency of data stored in the CNI memory 14 may need to be ensured, if more than one Packaging Engine operate on the same V-Frame/Frame. This can be achieved by a proper alignment of Message Boxes in the CNI memory.

In the exemplary embodiment of a Hardware FT/COM discussed here, desirably two communication channels are used. In general, also more than two communication channels may be deployed. Furthermore, referring again to FIG. 1, additional components, in particular coprocessors, (not shown) may be present between the host computer 11 and the communication controller (TTP controller) 121.

In the following, the Packaging Engine 4 is explained in further detail.

Packaging Engine—Internal Structure

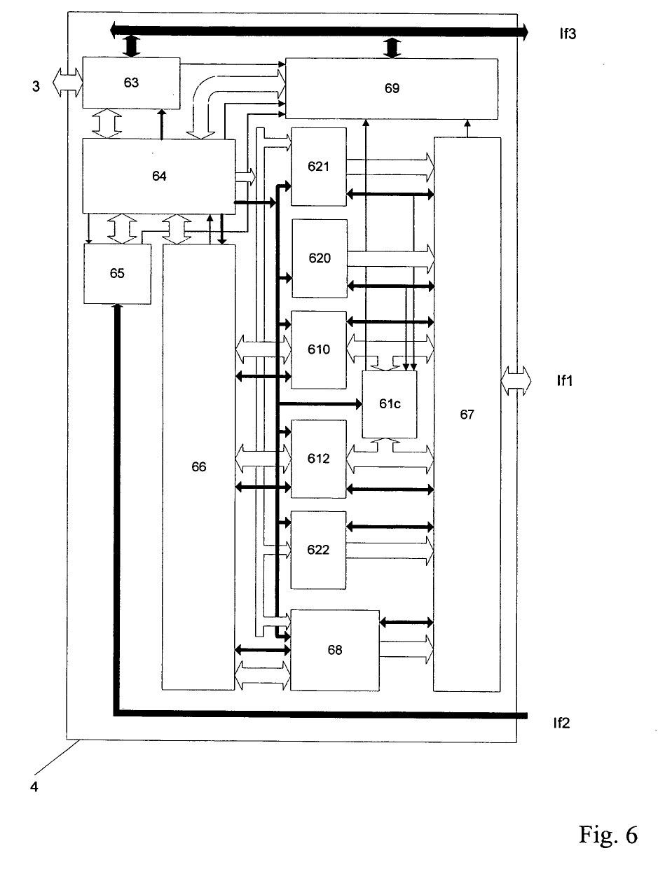

Referring to FIG. 6, the Packaging Engine 4 may include a Status and Control unit 69, a set of Data FIFOs 610, 612 (namely, Data FIFO F=610 and Data FIFO VF=612) and Address Generators 620, 621, 622 (namely, Addr Gen Ch0=620, Addr Gen Ch1=621 and Addr Gen VF=622), a Comparator 61c, a C-MEDL Access Controller 63, an Action Time Controller 65, a Bit Shifter 66, a Message Memory Access Controller 67, a Set-Reset unit 68 and a Sequencer 64.

The Sequencer 64 is the core component of the Packaging Engine 4. The Sequencer 64 fetches packaging information from the C-MEDL and generates all control signals which may be required to pack/unpack a frame. The Address Generators calculate the CNI memory addresses which maybe fetched/stored next. For this purpose, they may get the start address and the length information of each Message Box from the Sequencer 64. The Address Generators 621, 620 assigned to channel 1 and channel 0 share a common Data FIFO (=Data FIFO F) 610. To share a common Data FIFO is an optimization. It is also contemplated that two separated FIFOs may be implemented for channel 0 and channel 1, which may be assigned to the corresponding address generators. The following explanation relates to the optimized implementation.
(a) If no redundant Message Boxes were received or transmitted, then only one Address Generator may be active and thus only one Data FIFO may be required.
(b) If a redundant Message Box was received, then both Address Generators may be activated. In this case, the Message Memory Access Controller redirects the data (and the associated control signals) fetched by Address Generator Ch0 to the data bus associated to Data FIFO V F. In contrast, to Data FIFO F, Data FIFO V F may not store the data provided by the Message Memory Access Controller. Instead a speculative unpack procedure starts concurrently to the compare process, which uses the data of Data FIFO F as input and writes the unpacked data into DATA FIFO V F. This may require Address Generators and Data FIFOs to be configured independently.
(c) If a Message Box should be transmitted on both channels, then the Message Memory Access Controller may perform two write operations before a (write-) acknowledge is generated: For the first write operation, the address provided by Address Generator Ch1 is used. For the second write operation, the address of Address Generator Ch0 may be used. The WriteAck will be generated only when both write operations have been performed, causing that the Address Generators to increment their addresses and the next data word is provided by the Data FIFO F.

The Data FIFO keeps data that may be stored to or fetched from the CNI memory. This implies that the data flow direction of the Data FIFOs may be configurable. The Message Memory Access Controller 67 coordinates the CNI memory accesses. Depending on the actual needs, the bandwidth of the MMU interface If1 may be assigned to a single component or shared between all components. If configured, redundant Message Boxes are compared bitwise by the Comparator unit 61c. A redundancy check failure may be signaled to the Status and Control Unit 69. This unit may contain all relevant status information and allows to setup the functionality of the hardware FT/COM. The C-MEDL Access Controller 53 coordinates the accesses to the C-MEDL memory 3 between the HIL (If3) and the Sequencer 64. The Action Time Controller 65 compares the Action Time specified in the C-MEDL and the reference time provided by the SCL over the interface If2 in order to determine the point in time where the next packaging process should occur.

Packaging Engine—Initialization

Subsequent to a reset the C-MEDL 3 is empty/non initialized. Thus, the Packaging Engine is automatically disabled. In this state the host CPU can download the C-MEDL description over the HIL port If3. When the download is complete, the host CPU activates the Packaging Engine by setting a corresponding bit in the control register in the Status and Control Unit 69. In this mode the host CPU has no access to the C-MEDL memory. In case of a hardware or software reset this bit is cleared and consequently the Packaging Engine is automatically disabled.

However the host CPU still has the possibility to disable the Packaging Engine again and thus acquire full access to the C-MEDL memory. Similar to the C-MEDL, the control register of the hardware FT/COM may be initialized by the hardware FT/COM.

Packaging Sequence

The Packaging Engine starts to read the C-MEDL memory at the address 0×0000, see FIG. 7. The first fields contain the C-MEDL Header 71. The Sequencer compares the C-MEDL Description Identifiers stored in the C-MEDL Header with the identifier specified in the control register and jumps to the selected C-MEDL Description.

The first entry of a C-MEDL Description 72 is the Action Time, where the first frame of the selected cluster round should be processed. This value is copied by the Sequencer into the Action Time Controller. This unit compares the reference time with the value provided by the Sequencer and generates a Start Pack signal if both values match. If the reference value is greater than the Action Time specified in the C-MEDL, then a Fatal Error may be signaled.

Next to the Action Time, the addresses of the Message Box will be read out. These values are stored in the Address Generators 620, 621, 622. After it, the first Message Box description follows. The Message Box Control field is evaluated by the Sequencer 64 in order to setup the Packaging Engine.

Note that the above mentioned tasks can take place independently from the specified Action Time, due to the fact that they perform no message data manipulation. At this point, the Packaging Engine waits until the Action Time Controller activates the StartPack signal.

When the StartPack signal becomes active, then all components of the Packaging Engine will be activated and the packaging procedure starts. Depending on the configuration a redundancy check may be performed previously to the packaging procedure.

The hardware FT/COM processes the C-MEDL in a cyclic manner. This means that when the last Message Box of a cluster round was processed, then the hardware FT/COM may jump to the first address of the C-MEDL and the described sequence may start again.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for processing data frames exchanged over a communication controller between a host computer and a time-triggered communication network, comprising:
reading a data frame from an interface data storage means accessible over a first interface,
processing at least part of the data frame in at least one processor means, wherein data contained in said data frame is processed according to packaging information contained in a configuration table, and
storing portions of user data in the data frame in an associated memory range or set of registers of said interface data storage means as defined in said packaging information.

2. The method according to claim 1, wherein the processing according to the configuration table includes adjusting a data format, by at least one of (a) adjusting to the word length of the host computer, (b) adjusting the byte order to that of the host computer and/or (c) adjusting a data range or set of registers of the user data processed.

3. The method according to claim 1, wherein data which is originating from the host computer to be sent to the communication network, are composed into a data frame using data from at least two memory regions defined by the host computer according to the configuration table.

4. The method according to claim 1, further comprising generating a data status, said data status including (a) information about the channel over which the data are received, (b) information whether data are sent in a redundant way and (c) a message age.

5. The method according to claim 1, wherein newly received, unvalidated data is prevented from overwriting valid data and the message age of the data present in the memory or set of registers is adapted accordingly.

6. The method according to claim 1, wherein data selected to be sent is composed into a data frame from i) at least two memory ranges, ii) sets of registers, or iii) any combination of memory range and set of registers defined by the host computer according to the configuration table and the memory ranges or sets of registers being set/reset to a predetermined pattern after the data frame has been sent.

7. The method according to claim 1, wherein in the configuration table, times are defined when the data are read/written in the memory regions jointly used with the host computer and/or the memory regions jointly used with the communication controller.

8. The method according to claim 1, wherein an address where the data are made available to the host computer are stored in the configuration table.

9. The method according to claim 1, wherein the configuration table describes types of operations which are executed during a data transfer between the communication controller and the host computer.

10. The method according to claim 1, wherein redundant data transfer portions of valid data are selected according to a prescription defined in the configuration table to make data portions received in a redundant way available to the host computer once.

11. The method according to claim 10, wherein the redundant data transfer portions are checked for equality.

12. The method according to claim 1, wherein different tasks belonging to the processing of data frames are performed in parallel in a number of processing means provided in the communication controller.

13. A processing device for a communication controller processing data frames exchanged between a host computer and a time-triggered communication network comprising:
a processor means, and
a first interface for accessing an interface data storage means,
wherein said processor means is adapted to process at least part of a data frame read from said interface data storage means according to packaging information contained in a configuration table, and to store portions of the user data in the data frame in an associated memory range or set of registers of said interface data storage means as defined in said packaging information.

14. The processing device according to claim 13, further comprising said configuration table.

15. The processing device according to claim 13, further comprising a second interface adapted to be connected to the host computer for the exchange of packaging information.

16. The processing device according to claim 13, further comprising a third interface adapted to be connected to a protocol processor of said communication controller for the exchange of synchronization data such as a time reference signal.

17. A method for processing data frames according to claim 1, wherein processing at least part of the data frame includes processing at least part of the data frame in at least one processor means provided in said communication controller.
